(19) United States
(12) Patent Application Publication
(10) Pub. No.: US 2015/0369726 A1
(43) Pub. Date: Dec. 24, 2015

(54) IMAGE MEASURING APPARATUS AND IMAGE MEASURING METHOD

(71) Applicant: MITUTOYO CORPORATION, Kanagawa (JP)

(72) Inventor: Masaki KURIHARA, Kanagawa (JP)

(73) Assignee: MITUTOYO CORPORATION, Kanagawa (JP)

(21) Appl. No.: 14/725,583

(22) Filed: May 29, 2015

(30) Foreign Application Priority Data
Jun. 18, 2014 (JP) 2014-125416

(51) Int. Cl. G01N 21/27; G01B 11/00

(52) U.S. Cl. CPC G01N 21/27; G01B 11/00; G01N 2201/062; G01N 2201/12

(57) ABSTRACT

An image measuring apparatus includes: a visible light source emitting each light of a blue region, a green region, and a red region; an infrared light source emitting light of an infrared region; an image capturer receiving at least one of reflected light or transmitted light of an object, and converting the light to an electric signal; an optical system passing each light of a visible light region and the infrared region with respect to an object to the image capturer without changing a relative position between the object and the image capturer; an intensity controller separately controlling each light amount of the blue region, the green region, the red region, and the infrared region; and a calculator detecting information of the object by processing the electric signal obtained after converting at the image capturer.

### CROSS-REFERENCE TO RELATED APPLICATIONS

The present application claims priority under 35 U.S.C. §119 of Japanese Application No. 2014-125416, filed on Jun. 18, 2014, the disclosure of which is expressly incorporated by reference herein in its entirety.

### BACKGROUND OF THE INVENTION

1. Field of the Invention

The present invention relates to an image measuring apparatus and an image measuring method, which obtain an image of an object by emitting light at an object being measured, and measure a size, a height, a shape and the like.

2. Description of Related Art

An image measuring apparatus includes: a light source emitting light on an object being measured; an image capturer capturing an image of the object; and a calculator which analyzes the image captured by the image capturer and calculates a size and the like of the object. Among the image measuring apparatuses of this type, an optical measuring apparatus described in Japanese Patent Laid-open Publication No. 2012-128295 discloses a configuration of a visible observer performing a visible observation of the object, and a special observer performing a special observation of the object. The visible observer captures return light of the object to be measured using white light, and the special observer captures return light of the object to be measured using near-infrared or an excitation light. As a result, not only the visible observation, but also the special observations such as a near-infrared observation and a fluorescence observation, can be performed.

However, the configuration which measures an object using light of different wavelengths requires an optical system such as an object lens or the like corresponding to each one of a plurality of light sources, causing an increase in size of the measuring apparatus. Additionally, when the same location of the object is observed with light of different wavelengths, a position matching of the respective optical system and the object needs to be performed. The time required for such a position matching causes a drop of a measurement throughput. Moreover, the image obtained via each one of the optical system may cause a positioning drift, thereby decreasing measurement accuracy.

### SUMMARY OF THE INVENTION

An advantage of the present invention is to provide an image measuring apparatus and an image measuring method that are capable of measuring the object in a short time with a high level of accuracy, using light of a plurality of wavelengths.

The image measuring apparatus of the present invention includes: a visible light source emitting light of a blue region, a green region, and a red region of a visible light region; an infrared light source emitting light of an infrared region; an image capturer receiving at least one of reflected light or transmitted light and converting the light to an electric signal; an optical system leading each light of the visible light region and the infrared region with respect to an object without changing a relative positional relationship between the object and the image capturer; an intensity controller separately controlling each light amount of the blue region, the green region, the red region, and the infrared region; and a calculator detecting information of the object by processing the electric signal output from the image capturer.

According to this configuration, when detecting the information of the object using light of the visible light region and the infrared region, the visible light image and the infrared image of the object can be captured all together because each light of the visible light region and the infrared region is led to the image capturer without changing a relative positional relationship between the object and the image capturer. Additionally, since each light amount of the blue region, the green region, the red region, and the infrared region is controlled separately, an enhanced targeted image can be captured by balance adjustment of the blue, the green, the red, and the infrared regions.

According to the image measuring apparatus according to the present invention, the infrared light source may be positioned on an opposite side of the optical system with respect to the object. With this configuration, a transmitted image of the object can be captured with the light of the infrared region. In addition, the infrared light source may be positioned on a same side with the optical system with respect to the object. With this configuration, a reflected image of the object can be captured with the light of the infrared region.

Moreover, an image measuring method of the present invention includes: generating each light of a visible light region and an infrared region by separately controlling a light amount of a blue region, a green region, a red region, and an infrared region; emitting the light of the visible light region and of the infrared light region at an object; simultaneously receiving each light of the visible light region and the infrared region of the object at an image capturer and converting the light to an electric signal without changing a relative positional relationship between the object and the image capturer; and detecting information of the object by processing the electric signal output from the image capturer.

According to this configuration, since the light amount of the blue region, the green region, the red region, and the infrared region is controlled separately, the enhanced targeted image can be captured by balance adjustment of the blue, the green, the red, and the infrared regions. Generally, each material has a respective specific transmission wavelength region. For example, the infrared light is known for transmitting single crystal silicon such as a silicon wafer. A measuring apparatus using transmission characteristics of the infrared light has also been commercialized. As a result, an internal state of an object which can not be observed only from a surface, such as a joining face of two silicones, can be measured.

According to the image measuring method of the present invention, when generating each light of the visible light region and the infrared region, a light amount of at least one of the blue region, the green region, and the red region is controlled in order to measure a reflected image of the object.

According to this configuration, an image can be captured depending on whether a measured image is a reflected image or a transmitted image of the object, and not only a reflected image of a surface, but also a transmitted image of inside the material can be measured, into which infrared light is transmitted.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view illustrating an image measuring apparatus according to a first embodiment;

FIG. 2 is a block diagram illustrating a configuration of the image measuring apparatus according to the first embodiment;

FIG. 3 is a schematic view illustrating an image capturer of the image measuring apparatus according to the first embodiment;

FIGS. 4A and 4B are schematic views illustrating a visible image and an infrared image;

FIGS. 5A to 5D are schematic views illustrating images obtained by adjusting light amounts; and

FIG. 6 is a flowchart illustrating a flow of an image measuring method according to a second embodiment.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

### First Embodiment

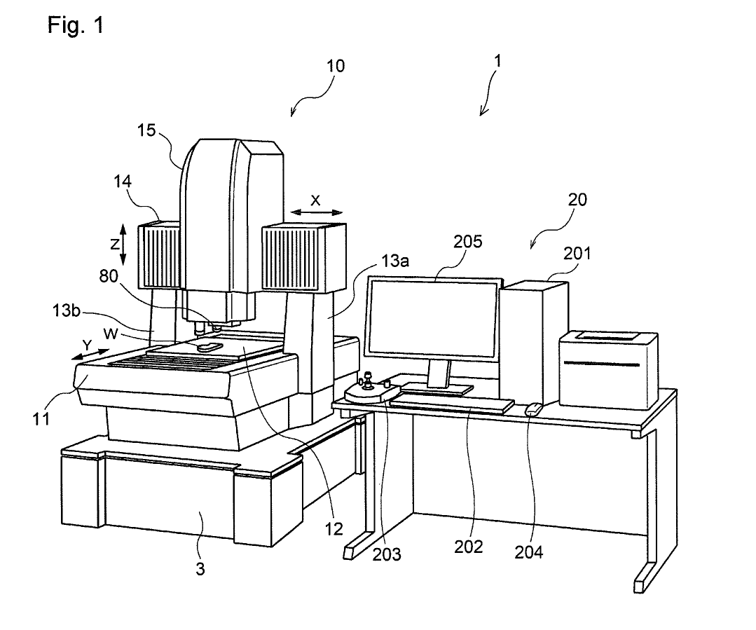

Hereafter, a first embodiment of the present invention is described with reference to the drawings. In the following description, identical reference numerals are assigned to the same portions and a description of those portions which have been previously described is omitted. FIG. 1 is a perspective view illustrating an image measuring apparatus according to an embodiment of the present invention. As shown in FIG. 1, the image measuring apparatus 1 according to the embodiment includes an apparatus main body 10 and a computer system 20. The apparatus main body 10 includes a table 11, a stage 12, an X-axis guide 14, and an image capture unit 15. For instance, the table 11 is positioned on an anti-vibration table 3 and inhibits transmission of external vibration to the stage 12 and the image capture unit 15 on the table 11.

The stage 12 is positioned on the table 11. The stage 12 is a table for mounting a work piece W, which is a measured object. The stage 12 is provided movable in a Y-axis direction (a direction along the Y-axis) by a Y-axis drive mechanism (not shown in the drawings) with respect to the table 11.

A support shaft 13a and 13b are provided on both sides of the table 11. The support shaft 13a and 13b are each provided extending upward from the sides of the table 11. The X-axis guide 14 is provided straddling over the support plate 13a and 13b. The image capture unit 15 is installed to the X-axis guide 14. The image capture unit 15 is provided movable in a X-axis direction (a direction along the X-axis) along the X-axis guide 14 by an X-axis drive mechanism (not shown in the drawings).

The image capture unit 15 is provided movable in a Z-axis direction (a direction along the Z-axis) by a Z-axis drive mechanism (not shown in the drawings). With this configuration, a relative positional relationship is configurable along the respective X-, Y-, and Z-axes between the work piece W on the stage 12 and the image capture unit 15. Specifically, adjusting the positional relationship allows bringing an image capture region for the image capture unit 15 together with a measurement region of the work piece W.

The computer system 20 includes a computer main body 201, a keyboard 202, a joystick 203, a mouse 204, and a display 205. The computer main body 201 controls motions and the like of the apparatus main body 10. The computer main body 201 controls motions of the apparatus main body 10 by a circuit of a control board and the like (hardware) and a program executed by a CPU (software). In addition, the computer main body 201 calculates information of the work piece W based on a signal output from the apparatus main body 10, and displays a calculation result on the display 205.

The joystick 203 is used for setting the image capture region of the work piece W. Specifically, the relative positional relationship between the work piece W and the image capture unit 15 is changed when a user operates the joystick 203, and the user can adjust the position of the image capture region displayed on the display 205.

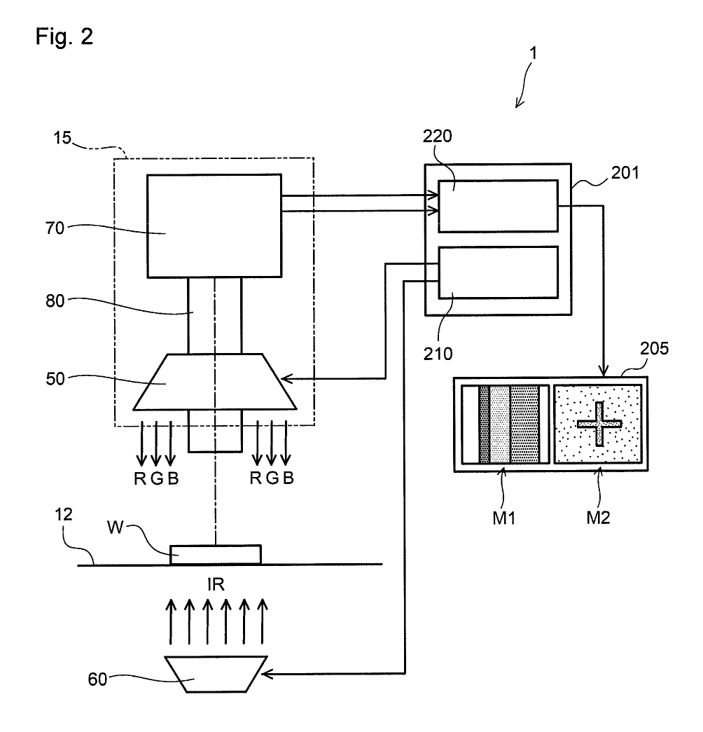

FIG. 2 is a block diagram illustrating a configuration of the image measuring apparatus according to the present embodiment. As shown in FIG. 2, the image capture unit 15 of the image measuring apparatus 1 includes a visible light source 50, an image capturer 70, and an optical system 80. In addition, an infrared light source 60 is provided below the stage 12 of the image measuring apparatus 1.

The visible light source 50 emits light of a blue region, a green region and a red region of a visual light region. In this example, light of the blue region is approximately a wavelength of 450 nm or greater and 495 nm or smaller. Light of the green region is approximately a wavelength of 495 nm or greater and 570 nm or smaller. Light of the red region is approximately a wavelength of 620 nm or greater and 750 nm or smaller.

The visible light source 50 is provided over the upper side of the stage 12 (a side where the work piece W is placed). The visible light source 50 is arranged in a position where visible light is emitted from above the work piece W. Moreover, the visible light source 50 may also be arranged in a position where visible light is emitted obliquely from above to the work piece W. For example, LED (Light Emitting Diode) is used for the visible light source 50.

The infrared light source 60 emits light of the infrared region. Light of the infrared region is longer than the wavelength of light of the red region and is approximately a wavelength of 2,500 nm or less. The infrared light source 60 is provided below the stage 12 (on the opposite side where the work piece W is placed). Moreover, the infrared light source 60 may also be arranged above the stage 12. For example, infrared LED is used for the infrared light source 60.

The image capturer 70 includes image capture elements such as a CCD (Charge Coupled Device) sensor, a CMOS (Complementary Metal-Oxide Semiconductor) sensor and the like. The image capturer 70 converts from at least one of reflected light or transmitted light of the work piece W to an electric signal. In the present embodiment, the image capturer 70 can capture light in both the visible light region and the infrared region all together.

The optical system 80 transmits each light of the visual light region and the infrared region to the image capturer 70 without changing the relative positional relationship between the work piece W and the image capturer 70. For example, an optical axis of the optical system 80 is common with each light of the visual light region and the infrared region. The optical system 80 may also be configured so as to branch, in the middle, a light pass of light of the visual light region and the infrared region, respectively.

In the present embodiment, the image measuring apparatus can be compact since there is no need to provide an optical system separately corresponding to light of the visible light region and the infrared region, respectively. In addition, when capturing an image from light of the visible light region of the work piece W (visible image M1) and an image from light of the infrared region (infrared image M2), these images can be obtained by one optical system 80 and the image capturer 70 simultaneously. Accordingly, there is no need to change or switch the image capture unit 15 when capturing each of the visible image M1 and the infrared image M2 and it becomes possible to obtain the visible image M1 and the infrared image M2 on the same location of the work piece W.

The computer main body 201 of the image measuring apparatus 1 includes an intensity controller 210 and a calculator 220. The intensity controller 210 controls a light amount of the blue region, the green region, and the red region in the visible light source 50 and the light amount of the infrared region in the infrared light source 60 separately. The intensity controller 210 controls an amperage and the like provided to the visible light source 50 and the infrared light source 60. As a result, an amount of light in each wavelength can be adjusted separately.

The calculator 220 detects information of the work piece W after processing the electric signal output from the image capturer 70. The calculator 220 performs a predetermined calculation using the visible image M1 and the infrared image M2 captured by the image capturer 70, and then calculates a surface state, an external form, a pore size, a height and the like of the work piece W.

The result detected from the calculator 220 is displayed on the display 205. In addition, the visible image M1 of the work piece W and the infrared image M2 of the work piece W captured by the image capturer 70 are displayed on the display 205. The visible image M1 and the infrared image M2 may be displayed on the display 205 in parallel or separately by switching.

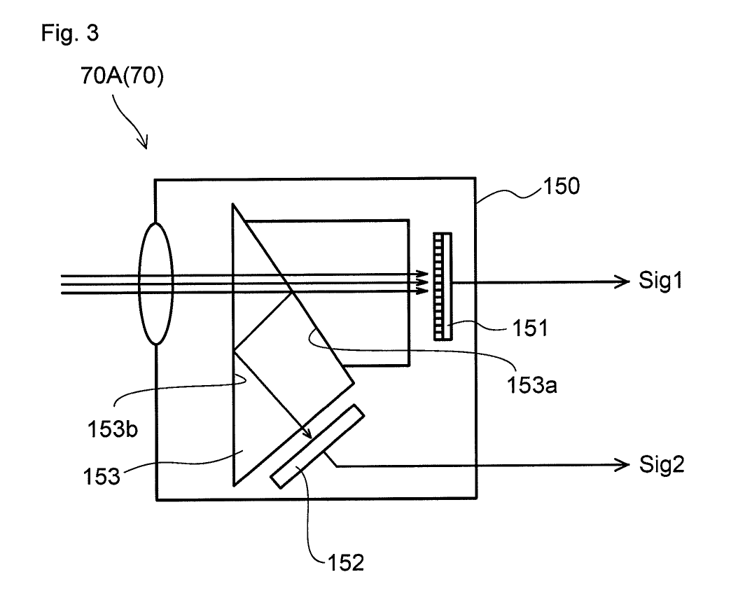

FIG. 3 is a schematic view illustrating an image capturer of the image measuring apparatus according to the present embodiment. As shown in FIG. 3, an image capturer 70A includes a first image capture element 151, a second image capture element 152, and a prism 153. The first image capture element 151 is, for example, a CCD converting to the electric signal after receiving visible light. The second image capture element 152 is, for example, a CCD converting to the electric signal after receiving infrared light.

The first image capture element 151, the second image capture element 152, and the prism 153 are incorporated in one casing 150. In the image capturer 70A, the light in the visible light region among light reaching the prism 153 passes through as is and reaches the first image capture element 151. In the meantime, the light in the infrared region reaches the second image capture element 152 by reflecting on a first surface 153a and a second surface 153b of the prism 153. The image capturer 70A allows capturing of an electric signal Sig1 based on the visible light from the first image capture element 151 and an electric signal Sig2 based on the infrared light from the second image capture element 152.

When detecting the information of the work piece W, the image measuring apparatus 1 with this type of configuration allows capturing of the visible image M1 and the infrared image M2 all together without changing the relative positional relationship between the work piece W and the image capturer 70.

Moreover, the image measuring apparatus 1 can control the light amount of the blue region, the green region, the red region, and the infrared region by the intensity controller 210 separately. Therefore, the image measuring apparatus 1 can capture an enhanced targeted image by balance adjustment of the light amount of the blue, the green, the red, and the infrared regions respectively.

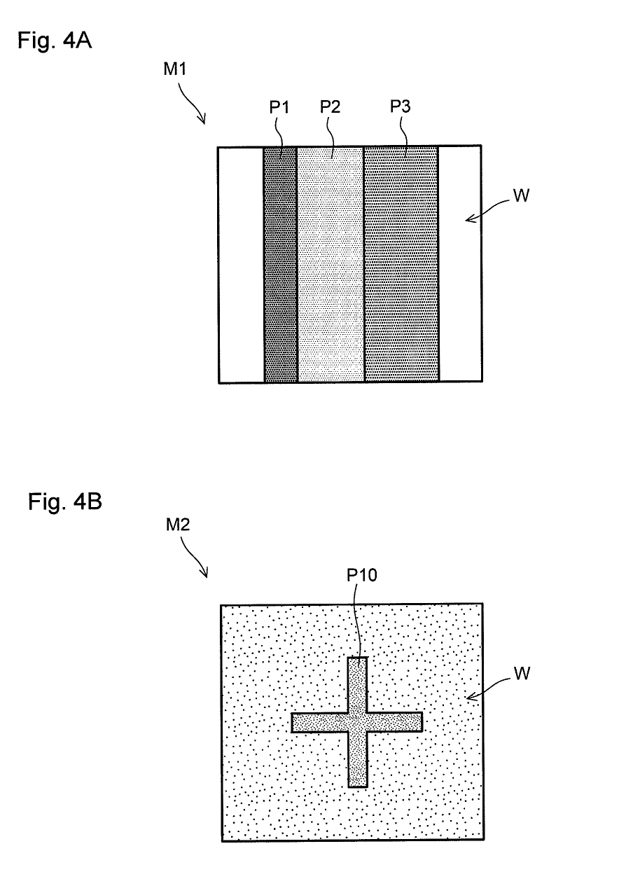

FIGS. 4A and 4B are schematic views illustrating a visible image and an infrared image. FIG. 4A shows an example of the visible image M1 of the work piece W, and FIG. 4B shows the infrared image M2 of the work piece W. The visible image M1 shown in the FIG. 4A is an image based on the reflected light of the visible light from the work piece W. The infrared image M2 shown in the FIG. 4B is an image based on the light of the infrared region which passed through the work piece W. Furthermore, both images are captured of the object from the same location of the work piece W.

The image measuring apparatus 1 according to the present embodiment can obtain the visible image M1 shown in FIG. 4A and the infrared image M2 shown in FIG. 4B at the same time. On the visible image M1 of the work piece W, images of a plurality of patterns P1, P2, and P3 are shown. Specifically, the images of the patterns P1, P2, and P3 reflected to the visible light are obtained. On the other hand, an image of a pattern provided inside the work piece W is not captured in the visible image M1.

The infrared image M2 shown in FIG. 4B is showing an image of a pattern P10 provided inside the work piece W. Specifically, the image of the pattern P10 of inside the work piece W is captured based on infrared transmitted light. On the other hand, the images of the patterns P1, P2, and P3 provided on the surface of the work piece W are not captured in the infrared image M2.

The image measuring apparatus 1 according to the present embodiment can measure not only the surface but also the internal status of the work piece W, by selectively using the visible image M1 and the infrared image M2 as appropriate according to a portion detected from the work piece W.

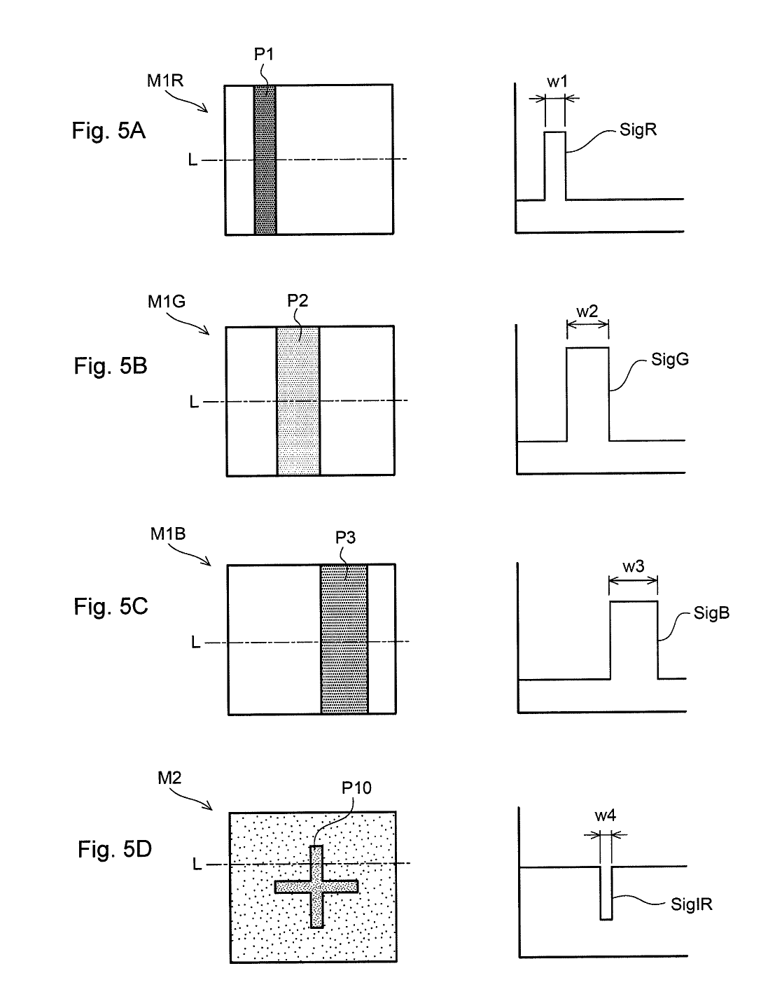

FIGS. 5A to 5D are schematic views illustrating images obtained by adjusting the amount of light. FIG. 5A shows a visible image M1R and a signal SigR when the light amount in the red region is increased. Specifically, the visible image M1R is captured by adjusting, by the intensity controller 210, so as to have more light amount of the red region compared to the other colors, of the visible light source 50. Because the light amount of the red region is greater, the image of the pattern P1 reflecting the red color the most is emphasized in the visible image MIR. The signal intensity along a detection line L of the visible image M1R is the signal SigR. A width w1 of the pattern P1, for example, is measured accurately by the signal SigR obtained from the visible image M1R.

FIG. 5B shows a visible image M1G and a signal SigG when the light amount of the green region is increased. Specifically, the visible image M1G is captured by adjusting, by the intensity controller 210, so as to have more light amount of the green region compared to the other colors, of the visible light source 50. Because the light amount of the green region is greater, the image of the pattern P2 reflecting the green color the most is emphasized in the visible image M1G. The signal intensity along the detection line L of the visible image M1G is the signal SigG. A width w2 of the pattern P2, for example, is measured accurately by the signal SigG obtained from the visible image M1G.

FIG. 5C shows a visible image M1B and a signal SigB when the light amount of the blue region is increased. Specifically, the visible image M1B is captured by adjusting, by the intensity controller 210, so as to have more light amount of the blue region compared to the other colors, of the visible light source 50. Because the light amount of the blue region is greater, the image of the pattern P3 reflecting the blue color the most is emphasized in the visible image M1B. The signal intensity along the detection line L of the visible image M1B is the signal SigB. A width of w3 of the pattern P3, for example, is measured accurately by the signal SigB obtained from the visible image M1B.

FIG. 5D shows an infrared image M2 and a signal SigIR when the light amount of the infrared region is increased. Specifically, the infrared image M2 is captured by adjusting, by the intensity controller 210, so as to have more light amount of the infrared region compared to the other colors, of the infrared light source 60. Because the amount of the infrared region is greater, the image of the pattern P10 of the inside the work piece W is emphasized in the infrared image M2. The signal intensity along the detection line L of the infrared image M2 is the signal SigIR. A width of w4 of the pattern P10, for example, is measured accurately by the signal SigIR obtained from the infrared image M2.

In this way, the image measuring apparatus 1 according to the present embodiment can capture the image with an emphasis of the portion where the work piece W needs to be measured by adjusting balances among the blue, green, red, and infrared regions. It also allows accurate measuring of a targeted portion without being obstructed by an unnecessary image.

In addition, the image measuring apparatus 1 may adjust the balance among each light amount of the red, green, blue, and infrared regions depending on the situation when a reflected image or a transmitted image of the surface of the work piece W needs to be measured. For example, when the transmitted image of the work piece W needs to be measured, the light amount of the infrared region is increased. For example, when the reflected image of the work piece W needs to be measured, the light amount of the red, green, and blue regions is increased. With the balance adjustment of these regions, the image measuring apparatus 1 can capture the reflected image and the transmitted image accurately.

Moreover, the image measuring apparatus 1 may emphasize the targeted image by performing a predetermined calculation using at least one of the visible images M2R, M1G, and M1B, and the infrared image M2. In addition, the image measuring apparatus 1 may emphasize the target image by performing a predetermined calculation using at least two of the visible images M1R, M1G, and M1B.

For example, when a semiconductor element having a plurality of wiring layers is the work piece W, the visible images M1R, M1G, and M1B are captured with an emphasis according to the material of the wiring layers. Also, an overlap condition of the chosen wiring layers can be detected by displaying the images selected among the visible images M2R, M1G, and M1B. In addition, the visible images M1R, M1G, M1B, and the infrared image M2 can be captured, with an emphasis according to the depth of the wiring layers, and the selected images can be displayed in layers.

### Second Embodiment

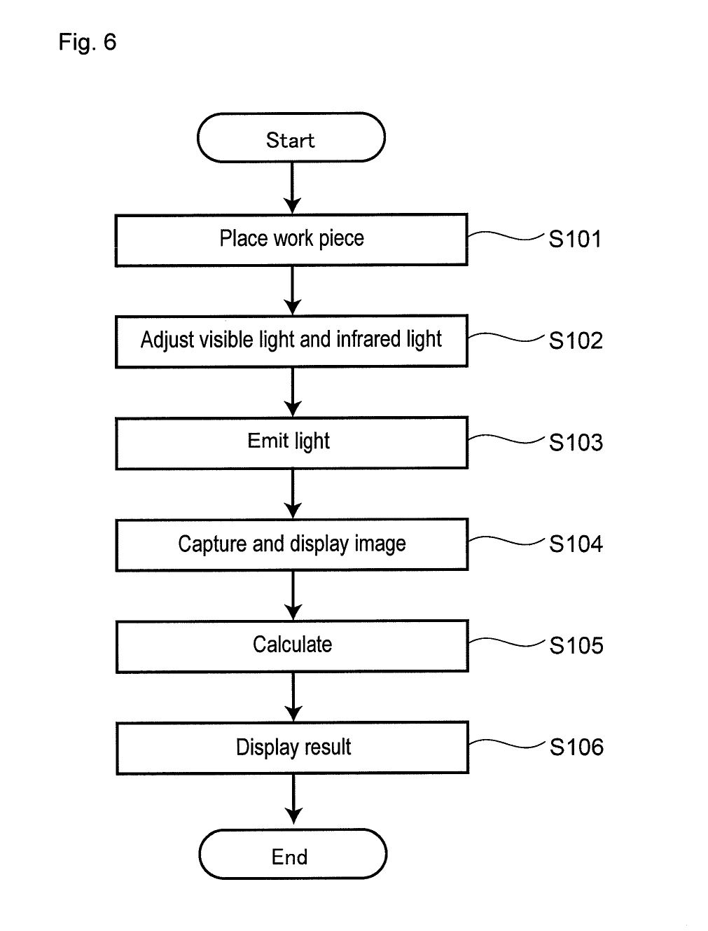

Hereafter, an image measuring method according to a second embodiment of the present invention is described. In the present embodiment, the image measuring method using the image measuring apparatus 1 is described. FIG. 6 illustrates a flowchart illustrating a flow of the image measuring method according to the present embodiment. First, a work piece W is placed on the stage 12 (Step S101). Next, a light amount of the visible light source 50 and the infrared light source 60 is adjusted. Specifically, each light amount of the blue, green, red, and infrared regions is adjusted respectively by the intensity controller 210, and a desired balance is established. Also, the balance-adjusted light is emitted on the work piece W (Step S103).

Next, at least one of the reflected light and the transmitted light from the work piece W is captured by the image capturer 70, and the visible image M1 and the infrared image M2 are displayed on the display 205 (Step S104). Next, calculation is performed based on the electric signal output from the image capturer 70 (Step S105). Finally, the calculation results are displayed on the display 205 (Step S106).

The image measuring method allows capturing of an image of an area to be measured in the work piece W with an emphasis, by balance adjustment of light of the blue, green, red, and infrared regions.

Furthermore, at least a portion of such an image measuring method may be realized using a program processing by the computer system 20. Further, the program may be stored in a computer-readable record medium or be delivered through a network.

As described above, the present embodiment provides the image measuring apparatus 1 and the image measuring method capable of measuring the work piece W with a high level of accuracy in a short period of time using the light by a plurality of wavelengths.

A description of the present embodiment was provided above; however the present invention is not limited to these examples. For example, the configuration equivalent to the computer system 20 in the image measuring apparatus 1 may be incorporated in the apparatus main body 10. With respect to each of the above embodiments, an individual skilled in the art may suitably add, remove, or modify the design of the configuration elements as well as the appropriate configurations of each embodiment character; such modifications are also included in the scope of the present invention as long as they fall within the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An image measuring apparatus comprising:
a visible light source configured to emit visible light as blue light, green light and red light;
an infrared light source configured to emit infrared light;
an image capturer configured to receive at least one of reflected light and transmitted light of an object, and converting the received light to an electric signal;
an optical system configured to pass the blue light, green light, red light and infrared light with respect to the object to the image capturer without changing a relative positional relationship between the object and the image capturer;
an intensity controller configured to separately control each light amount of the blue light, green light, red light and infrared light; and
a calculator configured to detect information of the object by processing the electric signal output from the image capturer.

2. The image measuring apparatus according to claim 1, wherein the infrared light source is located on an opposite side of the optical system with respect to the object.

3. The image measuring apparatus according to claim 1, wherein the infrared light source is located on a same side of the optical system with respect to the object.

4. An image measuring method comprising:
generating each of a visible light and an infrared light by separately controlling a light amount of blue light, green light, red light and infrared light;
emitting the visible light and the infrared light at an object;
simultaneously receiving each of the visible light and the infrared light of the object at an image capturer, and converting the light to an electric signal without changing a relative positional relationship between the object and the image capturer; and
detecting information of the object by processing the electric signal output from the image capturer.

5. The image measuring method according to claim 4, wherein when generating each of the visible light and infrared light, at least one light amount of the blue light, green light, red light and infrared light is controlled based on whether or not a detection position of the object is a surface or an inner side.
